(19) United States
(12) Patent Application Publication
(10) Pub. No.: US 2015/0140397 A1
(43) Pub. Date: May 21, 2015

(54) MULTILAYER FILM, EXTERIOR MATERIAL FOR SECONDARY BATTERY, SECONDARY BATTERY, AND ELECTRONIC DEVICE

(71) Applicant: SEMICONDUCTOR ENERGY LABORATORY CO., LTD., Atsugi-shi (JP)

(72) Inventors: Ryota TAJIMA, Isehara (JP); Yuugo GOTO, Isehara (JP); Yumiko YONEDA (Former: SAITO), Isehara (JP); Junya GOTO, Atsugi (JP); Takuya MIWA, Atsugi (JP)

(21) Appl. No.: 14/537,018

(22) Filed: Nov. 10, 2014

(30) Foreign Application Priority Data
Nov. 15, 2013 (JP) 2013-236672

(51) Int. Cl. H01M 2/02

(52) U.S. Cl. CPC H01M 2/0275; H01M 2/026; H01M 2/0262; H01M 2/0287; H01M 2220/20; H01M 2220/30
USPC 429/127; 429/176

(57) ABSTRACT

A novel multilayer film, a multilayer film suitable for an exterior material for a secondary battery, or a multilayer film that can be favorably used for a secondary battery suitable for a portable information terminal is provided. At least a metal layer and a resin layer are stacked as the multilayer film. A resin that constitutes the resin layer preferably has a durometer hardness of A90 or less, preferably A60 or less. Further, it is preferable that the resin be a material that does not break even when it is stretched to 150% of its original length, more preferably to 200% of its original length, in one direction. The thickness of the resin layer is preferably greater than or equal to 100 μm and less than or equal to 5 mm, more preferably greater than or equal to 500 μm and less than or equal to 3 mm.

### BACKGROUND OF THE INVENTION

1. Field of the Invention

One embodiment of the present invention relates to a member for a secondary battery and a manufacturing method thereof.

Note that one embodiment of the present invention is not limited to the above technical field. The technical field of one embodiment of the invention disclosed in this specification and the like relates to an object, a method, or a manufacturing method. In addition, one embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a storage device, a method for driving any of them, and a method for manufacturing any of them.

Note that electronic devices in this specification mean all devices including secondary batteries, and electro-optical devices including secondary batteries, information terminal devices including secondary batteries, vehicles including secondary batteries, and the like are all electronic devices.

2. Description of the Related Art

In recent years, portable information terminals typified by smartphones have been actively developed. Portable information terminals, which are a kind of electronic devices, are desired to be lightweight and compact by the users.

As an example of a wearable device with which information can be obtained visually without using hands at any place, Patent Document 1 is disclosed. Patent Document 1 discloses a goggle-type display device that includes a CPU and is capable of communication.

Most wearable devices and portable information terminals include secondary batteries that can be repeatedly charged and discharged. Wearable devices and portable information terminals have problems in that there is a limitation on the time for their operation because their lightweight and compactness limit the capacity of the secondary batteries. Secondary batteries used in wearable devices and portable information terminals should be lightweight and compact and should be able to be used for a long time.

Examples of the secondary battery include a nickel-metal-hydride battery and a lithium-ion secondary battery. In particular, lithium-ion secondary batteries have been actively researched and developed because the capacity thereof can be increased and the size thereof can be reduced.

Although metal cans used to be used as exterior materials for containing lithium-ion secondary batteries, multilayer films of metal and resin have been recently used because they are lightweight and excellent in heat dissipation, and the shape thereof can be selected freely.

### PATENT DOCUMENT

### [Patent Document 1] International Publication WO 2012/050182 Pamphlet

### SUMMARY OF THE INVENTION

An object of the present invention is to provide a novel multilayer film.

Another object is to provide a multilayer film suitable for an exterior material for a secondary battery.

Another object is to provide a multilayer film that can be favorably used for a secondary battery suitable for a portable information terminal. Another object is to provide a novel film or the like.

Another object is to provide a secondary battery suitable for a portable information terminal. Another object is to provide a novel power storage device or the like.

Another object is to provide a secondary battery suitable for a wearable device.

Another object is to provide an electronic device having a novel structure, specifically, an electronic device having a novel structure that can be changed in appearance in various ways. Another object is to provide an electronic device having a novel structure that can have various shapes and a secondary battery that fits the shapes of the electronic device.

Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the invention disclosed in this specification is a multilayer film including at least a metal layer and a first resin layer with a thickness of greater than or equal to 100 μm and less than or equal to 5 mm. A resin constituting the first resin layer is a material that has a durometer hardness of A90 or less and that does not break even when it is stretched to 150% of its original length in one direction.

Another embodiment of the invention disclosed in this specification is the multilayer film having the above structure, in which the metal layer includes aluminum.

Another embodiment of the invention disclosed in this specification is the multilayer film having the above structure, in which the metal layer and the first resin layer are stacked and in contact with each other.

Another embodiment of the invention disclosed in this specification is the multilayer film having the above structure, further including an adhesive layer between the metal layer and the first resin layer.

Another embodiment of the invention disclosed in this specification is the multilayer film having the above structure, further including a second resin layer.

Another embodiment of the invention disclosed in this specification is the multilayer film having the above structure, in which the second resin layer is on the opposite side of the metal layer from the first resin layer.

Another embodiment of the invention disclosed in this specification is the multilayer film having the above structure, in which the second resin layer has a thickness of greater than or equal to 100 μm and less than or equal to 5 mm. A resin constituting the second resin layer is a material that has a durometer hardness of A90 or less and that does not break even when it is stretched to 150% of its original length in one direction.

Another embodiment of the invention disclosed in this specification is the multilayer film having the above structure, in which a resin that constitutes either one or both of the first resin layer and the second resin layer has a durometer hardness of A60 or less.

Another embodiment of the invention disclosed in this specification is the multilayer film having the above structure, in which a resin that constitutes either one or both of the first resin layer and the second resin layer is a material that does not break even when it is stretched to 200% of its original length in one direction.

Another embodiment of the invention disclosed in this specification is the multilayer film having the above structure, in which a resin that constitutes either one or both of the first resin layer and the second resin layer is a silicone resin.

Another embodiment of the invention disclosed in this specification is the multilayer film having the above structure, in which at least part of the metal layer is embossed.

Another embodiment of the invention disclosed in this specification is an exterior material for a secondary battery, using the multilayer film having the above structure.

Another embodiment of the invention disclosed in this specification is a secondary battery using, as its exterior body, the multilayer film having the above structure.

In the above structure, the exterior body of the secondary battery can be deformed repeatedly from a flat state, within a range of a curvature radius of 10 mm or more, preferably a curvature radius of 30 mm or more. One or two films are used as the exterior body of the secondary battery. When the secondary battery with a laminated structure is bent to have an arc-shaped cross section, the battery is sandwiched by the two curved surfaces of the film. Approximating the curve in a cross section of the curved surface of the film by a circle, the radius is called curvature radius and the reciprocal is called curvature. Note that the cross-sectional shape of the secondary battery is not limited to a simple arc shape and the cross section can be partially arc-shaped. For example, the cross-sectional shape can be a wavy shape or an S shape.

Another embodiment of the invention disclosed in this specification is an electronic device incorporating the above secondary battery.

Examples of wearable devices include wearable input terminals such as a wearable camera, a wearable microphone, and a wearable sensor; wearable output terminals such as a wearable display and a wearable speaker; and wearable input/output terminals having the functions of any of the input terminals and any of the output terminals. Another example of a wearable device is a device that controls each device and calculates or processes data, typically, a wearable computer including a CPU. Other examples of wearable devices include devices that store data, send data, and receive data, typically, a portable information terminal and a memory.

### BRIEF DESCRIPTION OF THE DRAWINGS

In the accompanying drawings:

FIGS. 1A to 1D are each a cross-sectional view showing one embodiment of the present invention;

FIGS. 2A to 2C are each a cross-sectional view showing one embodiment of the present invention;

FIGS. 3A to 3C are each a cross-sectional view showing one embodiment of the present invention;

FIGS. 4A to 4C are each a cross-sectional view showing one embodiment of the present invention;

FIGS. 5A to 5C are each a cross-sectional view showing one embodiment of the present invention;

FIG. 6 is a top view showing one embodiment of the present invention;

FIGS. 7A to 7F show one embodiment of the present invention;

FIGS. 8A to 8E are top views illustrating one embodiment of the present invention;

FIGS. 9A and 9B are perspective views showing one embodiment of the present invention;

FIGS. 10A and 10B are perspective views showing one embodiment of the present invention;

FIGS. 11A and 11B are top views showing one embodiment of the present invention;

FIG. 12 is a cross-sectional view of an electronic device of one embodiment of the present invention;

FIGS. 13A to 13E illustrate electronic devices including flexible secondary batteries;

FIGS. 14A and 14B illustrate vehicles including secondary batteries; and

FIGS. 15A and 15B are external perspective views of an electronic device of one embodiment of the present invention.

### DETAILED DESCRIPTION OF THE INVENTION

Embodiments of the present invention will be described below in detail with reference to the drawings. However, the present invention is not limited to the description below, and it is easily understood by those skilled in the art that modes and details disclosed herein can be modified in various ways. Furthermore, the present invention is not construed as being limited to description of the embodiments below.

The term “electrically connected” includes the case where components are connected through an “object having any electric function”. There is no particular limitation on the “object having any electric function” as long as electric signals can be transmitted and received between the components connected through the object.

The position, size, range, or the like of each component illustrated in drawings and the like is not accurately represented in some cases for easy understanding. Therefore, the disclosed invention is not necessarily limited to the position, size, range, or the like disclosed in the drawings and the like.

The ordinal number such as “first”, “second”, and “third” are used to avoid confusion among components.

### Embodiment 1

A user can wear a wearable device more comfortably if the wearable device has a function of changing its shape in accordance with the body shape of the user. Thus, a display that can be changed in shape (i.e., a flexible display) has been developed for use in wearable devices. In view of use in wearable devices that are mobile devices, it is necessary that not only displays but also other components and batteries can be changed in shape.

Lithium-ion secondary batteries are seen as the favorite among other secondary batteries for wearable devices, since capacity thereof can be increased and size thereof can be reduced. In a lithium-ion secondary battery, hydrolysis reaction occurs between moisture and lithium salt used as an electrolyte (e.g., LiPF₆), which generates hydrofluoric acid. Therefore, a multilayer film used as an exterior material for the lithium-ion secondary battery has a function of preventing moisture from entering the battery. As a layer having that function, a metal layer is provided in many cases.

However, in a secondary battery that can be changed in shape, a crease is sometimes made in the metal layer by repeated deformation. The crease does not disappear even when the metal layer returns to the original shape, and the metal layer bends at the crease from the next deformation. In this way, a load concentrates on the crease portion, and the metal layer breaks from the crease portion in some cases.

In view of the above, one embodiment of the present invention provides a multilayer film that can be used as an exterior material for a secondary battery. The multilayer film is a stack of at least a metal layer and a resin layer, and a resin that constitutes the resin layer preferably has a durometer hardness of A90 or less, more preferably A60 or less. In addition, a material that does not break even when it is stretched to 150% of its original length in one direction, preferably a material that does not break even when it is stretched 200% of its original length, may be used as the resin. Furthermore, the thickness of the resin layer is preferably greater than or equal to 100 μm and less than or equal to 5 mm, more preferably, greater than or equal to 500 μm and less than or equal to 3 mm. The stacked metal layer and the resin layer may be in contact with each other, or another layer may be positioned between the metal layer and the resin layer. In addition, another layer may further be stacked. A preferred example of the material of such a layer is a silicone resin.

It is desirable if the multilayer film has a thickness of greater than or equal to 100 μm and less than or equal to 5 mm, preferably greater than or equal to 500 μm and less than or equal to 3 mm, throughout, for example. However, one embodiment of the present invention is not limited thereto. For example, the multilayer film may at least partly have a region with a thickness of greater than or equal to 100 μm and less than or equal to 5 mm, preferably greater than or equal to 500 μm and less than or equal to 3 mm. Alternatively, the multilayer film may have a region with a thickness of greater than or equal to 100 μm and less than or equal to 5 mm, preferably greater than or equal to 500 μm and less than or equal to 3 mm, desirably in 50% or more of the area of the multilayer film, more desirably in 90% or more of the area of the multilayer film.

The number of the resin layers to be provided may be one, two, or more. In a case where a plurality of the resin layers are provided, forming the plurality of the resin layers to sandwich the metal layer is preferred, because a crease is not easily made in the metal layer with such a structure.

In the multilayer film having such a structure, a crease is not easily made in the metal layer even by repeated deformation, and load concentration by repeated bending can be suppressed. Thus, with the use of this multilayer film as an exterior material for a secondary battery that can be changed in shape, a highly reliable secondary battery can be provided.

As the metal layer, a metal thin film of aluminum, stainless steel, nickel steel, or the like can be used. Aluminum is particularly preferred because it is easily handled. Furthermore, use of aluminum containing 0.5 to 2.0 wt % of iron is preferred because it is excellent in ductility and a pinhole is not easily formed therein. In addition, it is preferable that the aluminum film is subjected to degreasing treatment in order to increase resistance to an electrolytic solution or hydrofluoric acid (resistance to corrosion). Other than degreasing treatment, hot water modification treatment, anodic oxidation treatment, chemical conversion treatment, and coating treatment can also increase the resistance to corrosion. Performing the above treatment may form a corrosion-resistance layer in contact with the metal layer. A layer formed of a material with high resistance to corrosion may be attached to the metal layer with the use of an adhesive. The metal layer may be embossed, for example, to have an uneven surface.

In a case where the multilayer film is used as an exterior material for a secondary battery, the surface to be in contact with a cell of the secondary battery (i.e., one side of the multi-layer film) is preferably provided with a heat-seal layer for heat sealing. As the material for the heat-seal layer, a polyolefin resin such as polyethylene and polypropylene can be used.

Other than these layers, a base layer for improving the heat resistance and suppressing the generation of pinholes may be provided. As the base layer, a film formed of polyester, polyamide, or polypropylene is preferably used. A layer formed of an oriented polyamide film or an oriented polyester film is particularly preferred.

The above-described layers may be adhered to each other via an adhesive layer. The adhesive layer can be formed using a thermoplastic film material, a thermosetting adhesive, an anaerobic adhesive, a photo-curable adhesive such as a UV curable adhesive, or a reactive curable adhesive. As the material of the adhesive, an epoxy resin, an acrylic resin, a silicone resin, a phenol resin, or the like can be used. As the method for lamination, a variety of methods such as dry lamination, extrusion lamination, and hot melt lamination can be used. As a preferred example, dry lamination with a polyurethane-based two-part curable adhesive or the like may be used.

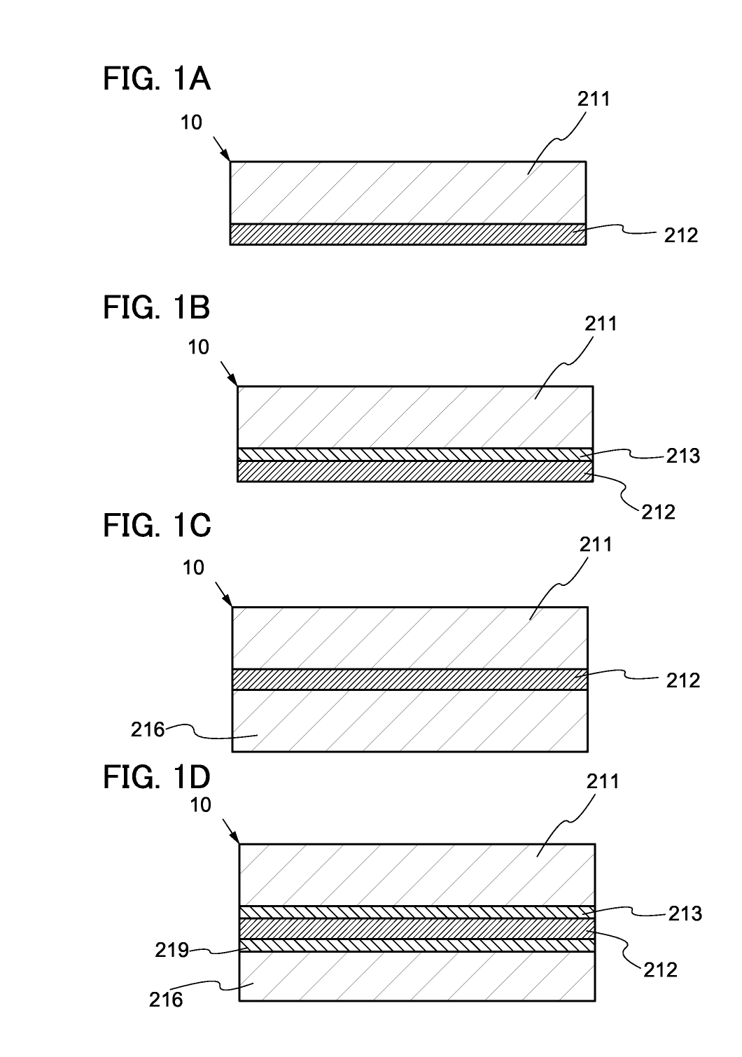

FIGS. 1A to 1D, FIGS. 2A to 2C, FIGS. 3A to 3C, FIGS. 4A to 4C, and FIGS. 5A to 5C each schematically show a multilayer film 10 of one embodiment of the present invention.

FIG. 1A shows a structure of the multilayer film 10 in which a resin layer 211 is stacked over a metal layer 212. The resin layer 211 can be formed by a coating method. In order to form the resin layer 211 having a desired thickness, the viscosity of a resin to be applied may be controlled, or the resin may be applied repeatedly. Alternatively, the metal layer 212 may be deposited onto the resin layer 211 by an evaporation method, a sputtering method, or the like.

FIG. 1B shows a structure of the multilayer film 10 in which the metal layer 212 and the resin layer 211 are adhered to each other with an adhesive layer 213. With the use of the adhesive layer 213, the multilayer film 10 can be fabricated by various lamination methods.

FIG. 1C shows a structure of the multilayer film 10 in which the resin layer 211 and a second resin layer 216 are provided in contact with the upper and lower sides of the metal layer 212, respectively. With this structure, the multilayer film 10 can have better resistance to bending. FIG. 1D shows a structure of the multilayer film 10 in which the resin layer 211 and the second resin layer 216 are adhered to the metal layer 212 with adhesive layers 213 and 219, respectively. The multilayer film 10 having this structure can be easily fabricated by a lamination method.

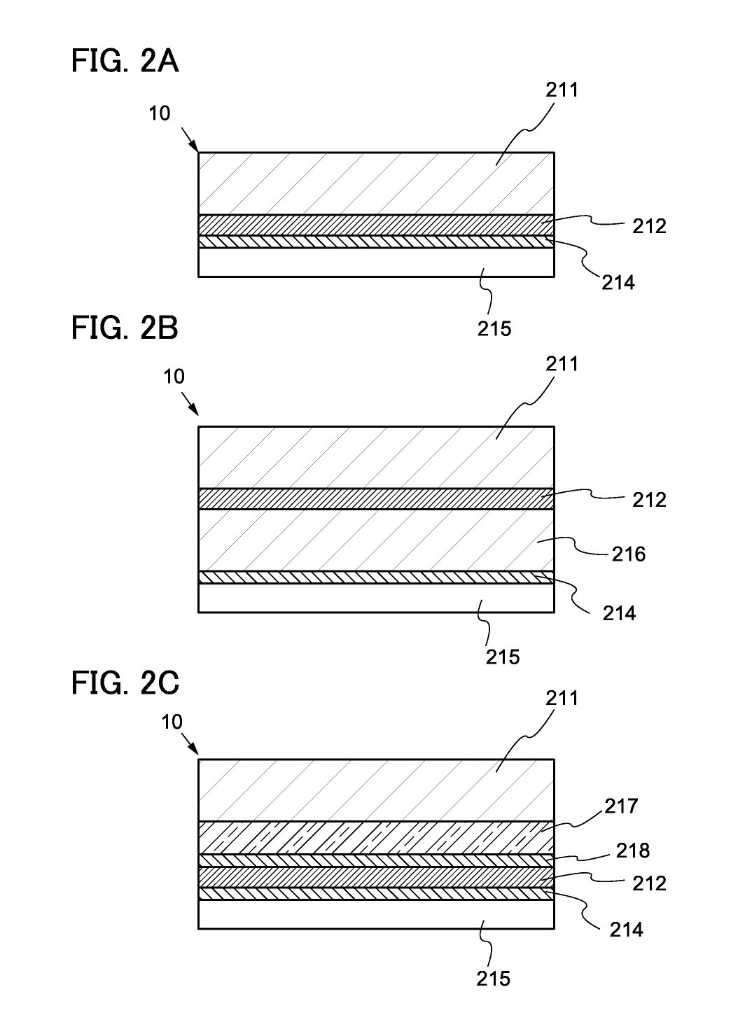

FIG. 2A shows a structure of the multilayer film 10 in which a heat-seal layer 215 is stacked, with the use of an adhesive layer 214, over the structure of FIG. 1A. FIG. 2B shows a structure of the multilayer film 10 in which the heat-seal layer 215 is stacked, with the use of the adhesive layer 214, over the structure of FIG. 1C. The provision of the heat-seal layer 215 makes it easy to fabricate an exterior body in the form of a bag by thermocompression bonding; therefore, the multilayer film 10 with the heat-seal layer 215 can be favorably used as an exterior material for a secondary battery.

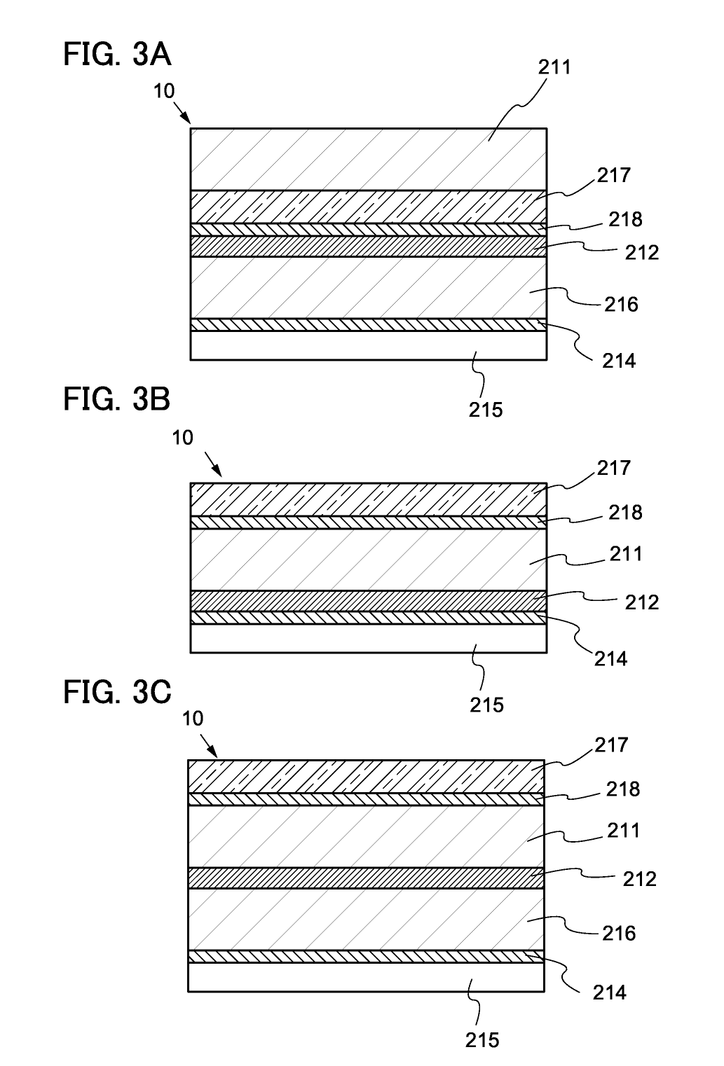

FIG. 2C shows a structure of the multilayer film 10 having the structure of FIG. 2A in which a base layer 217 is further provided between the metal layer 212 and the resin layer 211. FIG. 3A shows a structure of the multilayer film 10 having the structure of FIG. 2B in which the base layer 217 is further provided between the metal layer 212 and the resin layer 211. The base layer 217 may be stacked with the use of an adhesive layer 218 over the metal layer 212. FIG. 3B shows a structure of the multilayer film 10 having the structure of FIG. 2A in which the base layer 217 is further provided over the resin layer 211. FIG. 3C shows a structure of the multilayer film 10 having the structure of FIG. 2B in which the base layer 217 is further provided over the resin layer 211. The base layer 217 may be stacked with the use of the adhesive layer 218 over the resin layer 211.

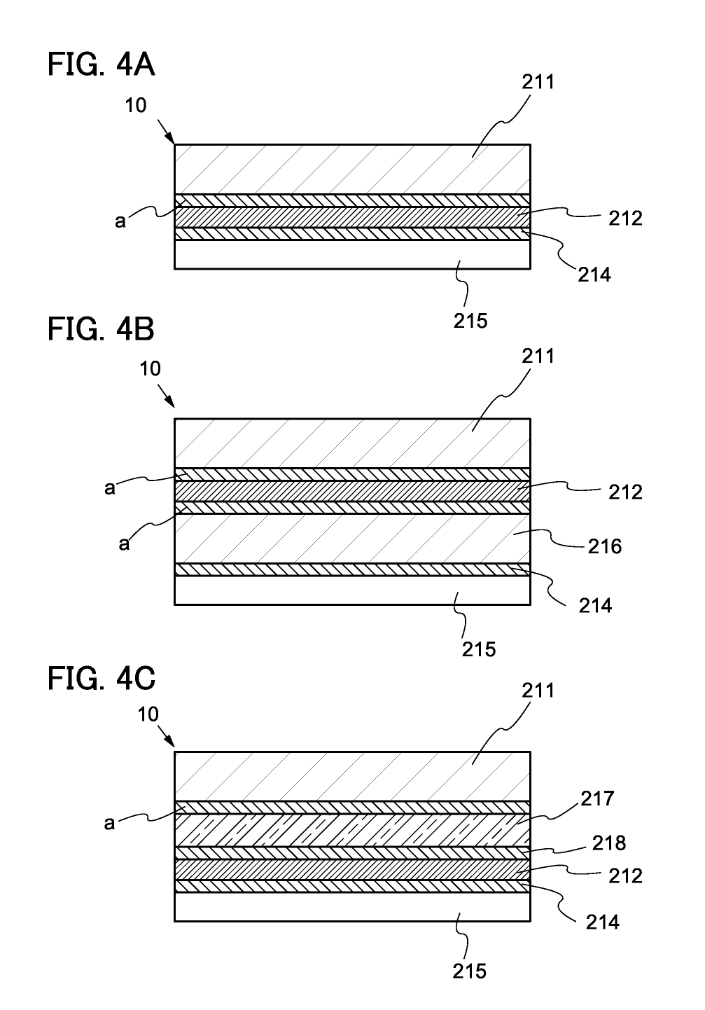

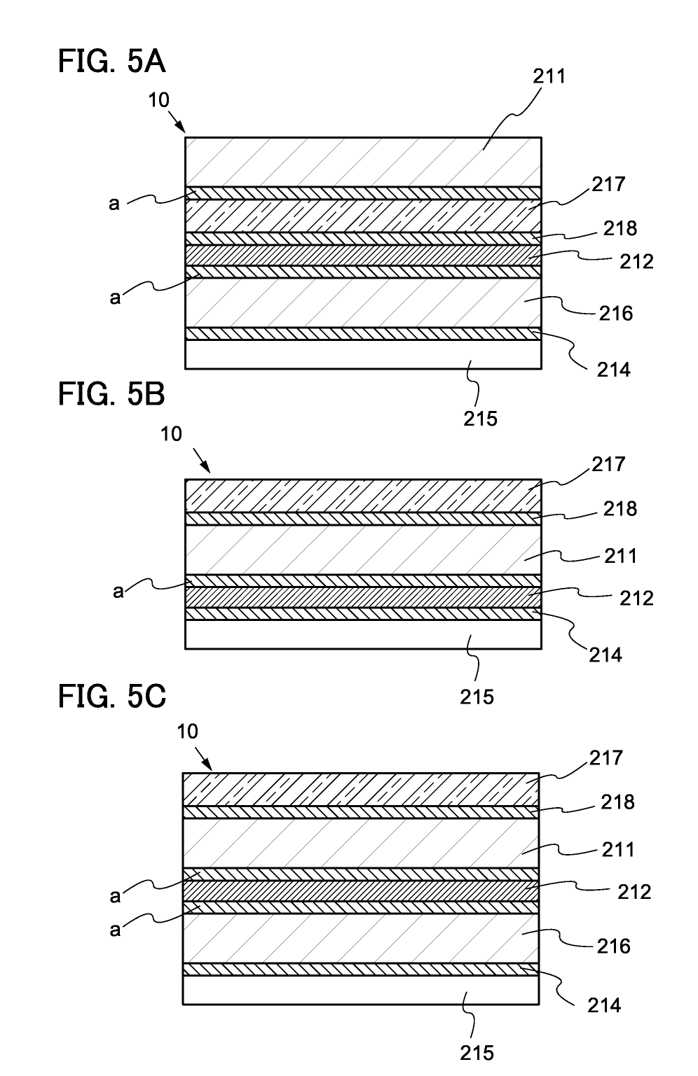

FIGS. 4A to 4C and FIGS. 5A to 5C are structural examples of the multilayer film 10 having the structures of FIGS. 2A to 2C and FIGS. 3A to 3C, in which the resin layer 211 and the second resin layer 216 are stacked with the use of an adhesive layer a. FIGS. 4A, 4B, and 4C correspond to FIGS. 2A, 2B, and 2C, respectively, and FIGS. 5A, 5B, and 5C correspond to FIGS. 3A, 3B, and 3C, respectively.

As described above, the multilayer film of one embodiment of the present invention may have a variety of structures. Not only the structures illustrated in the drawings but also other structures may be employed. Having a stack of the metal layer and the resin layer that satisfies the above conditions can suppress the generation of a crease in the metal layer caused by bending.

Note that the detailed structures and materials of the components constituting the multilayer film 10 are as described above.

The adhesive layers 214, 218, 219, and a may not necessarily be formed, if they are not needed.

In this embodiment, an example in which a lithium-ion secondary battery is fabricated with the use of the above-described multilayer film will be described.

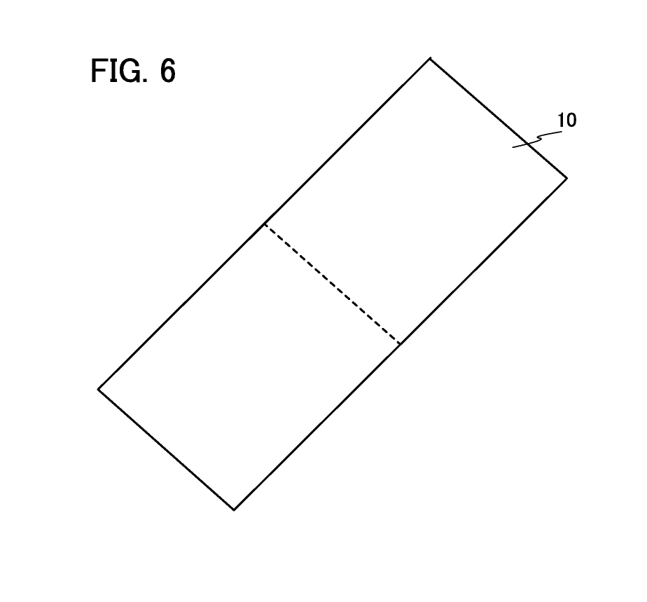

First, a multilayer film provided with the heat-seal layer 215, such as the one shown in FIGS. 2A to 2C, FIGS. 3A to 3C, FIGS. 4A to 4C, and FIGS. 5A to 5C, is cut to prepare a film 10 shown in FIG. 6.

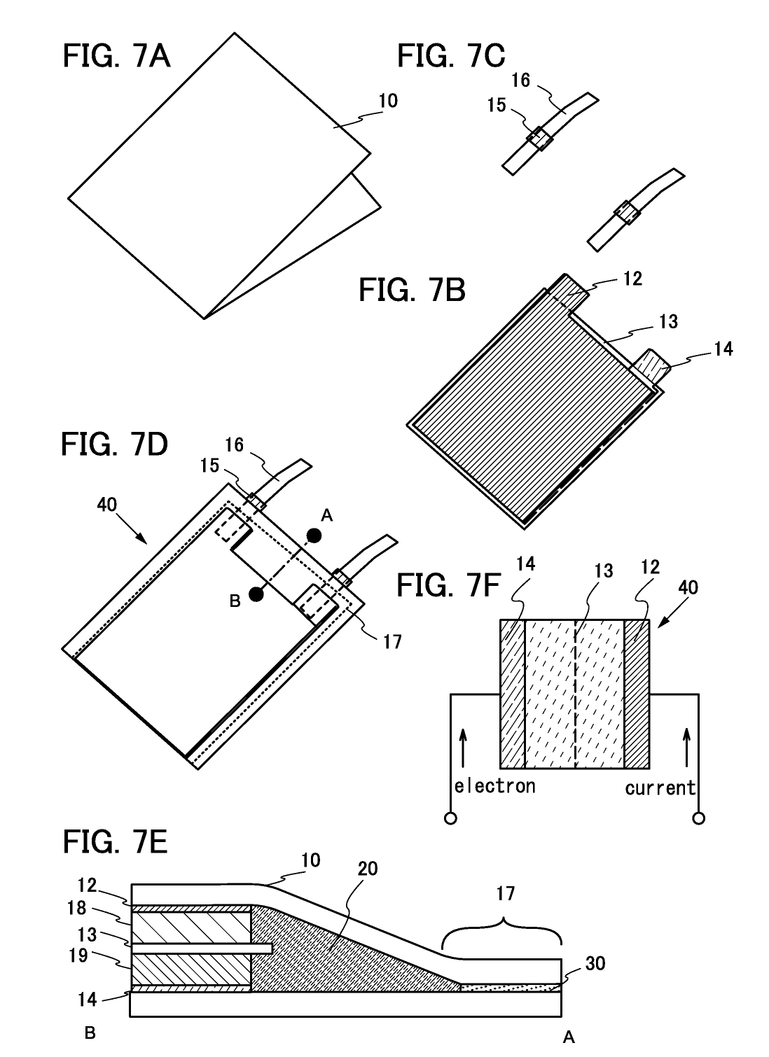

Then, the film 10 is folded along a dotted line so as to be in the state shown in FIG. 7A.

A positive electrode current collector 12, a positive electrode active material, a separator 13, a negative electrode active material, and a negative electrode current collector 14 that are stacked to constitute a secondary battery as illustrated in FIG. 7B are prepared. The positive electrode current collector 12 and the negative electrode current collector 14 can each be formed using a highly conductive material that is not alloyed with a carrier ion of, for example, lithium, and is not dissolve at the electric potential at the time of charge/discharge, such as a metal typified by gold, platinum, zinc, iron, nickel, copper, aluminum, titanium, and tantalum or an alloy thereof typified by stainless steel. Alternatively, an aluminum alloy to which an element that improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The current collectors can each have a foil-like shape, a plate-like shape (sheet-like shape), a net-like shape, a cylindrical shape, a coil shape, a punching-metal shape, an expanded-metal shape, or the like as appropriate. Each of the current collectors preferably has a thickness of greater than or equal to 10 μm and less than or equal to 30 μm. Note that the example in which one combination of the positive electrode current collector 12, the separator 13, and the negative electrode current collector 14 that are stacked is covered with an exterior body is illustrated here for simplicity. To increase the capacity of a secondary battery, a plurality of combinations may be stacked and covered with an exterior body.

In addition, two lead electrodes 16, one of which is for a positive electrode and the other of which is for a negative electrode, with sealing layers 15 illustrated in FIG. 7C are prepared. The lead electrodes 16 are each also referred to as a lead terminal and provided in order to lead the positive electrode or the negative electrode of a secondary battery to the outside of the exterior film.

Then, one of the lead electrodes is electrically connected to a protruding portion of the positive electrode current collector 12 by ultrasonic welding or the like. The other lead electrode is electrically connected to a protruding portion of the negative electrode current collector 14 by ultrasonic welding or the like.

Then, two sides of the film 10 are sealed by thermocompression bonding, and one side is left open for introduction of an electrolytic solution. In thermocompression bonding, the sealing layers 15 provided over the lead electrodes are also melted, thereby fixing the lead electrodes and the film 10 to each other. After that, in a reduced-pressure atmosphere or an inert atmosphere, a desired amount of electrolytic solution is introduced to the inside of the film 10 in the form of a bag. Lastly, the side of the film which has not been subjected to thermocompression bonding and is left open is sealed by thermocompression bonding.

In this manner, a secondary battery 40 illustrated in FIG. 7D can be manufactured.

FIG. 7E illustrates an example of a cross section taken along dashed-dotted line A-B in FIG. 7D.

As illustrated in FIG. 7E, the positive electrode current collector 12, a positive electrode active material layer 18, the separator 13, a negative electrode active material layer 19, and the negative electrode current collector 14 are stacked in this order and placed inside the folded film 10, an end portion is sealed with an adhesive layer 30, and the other space is filled with an electrolytic solution 20.

Examples of positive electrode active materials that can be used for the positive electrode active material layer 18 include a composite oxide with an olivine structure, a composite oxide with a layered rock-salt structure, and a composite oxide with a spinel structure. As the positive electrode active material, a compound such as LiFeO₂, LiCoO₂, LiNiO₂, LiMn₂O₄, V₂O₅, Cr₂O₅, and MnO₂ can be used.

Alternatively, a complex material (LiMPO₄ (general formula) (M is one or more of Fe(II), Mn(II), Co(II), and Ni(II))) can be used. Typical examples of the general formula LiMPO₄ which can be used as a material are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

Alternatively, a complex material such as Li(₂₋ⱼ)MSiO₄ (general formula) (M is one or more of Fe(II), Mn(II), Co(II), and Ni(II); 0≦j≦2) may be used. Typical examples of the general formula Li(₂₋ⱼ)MSiO₄ which can be used as a material are lithium compounds such as Li(₂₋ⱼ)FeSiO₄, Li(₂₋ⱼ)NiSiO₄, Li(₂₋ⱼ)CoSiO₄, Li(₂₋ⱼ)MnSiO₄, Li(₂₋ⱼ)FeₖNiₗSiO₄, Li(₂₋ⱼ)FeₖCoₗSiO₄, Li(₂₋ⱼ)FeₖMnₗSiO₄, Li(₂₋ⱼ)NiₖCoₗSiO₄, Li(₂₋ⱼ)NiₖMnₗSiO₄ (k+l≦1, 0<k<1, and 0<l<1), Li(₂₋ⱼ)FeₘNiₙCo_{q}SiO₄, Li(₂₋ⱼ)FeₘNiₙMn_{q}SiO₄, Li(₂₋ⱼ)NiₘCoₙMn_{q}SiO₄ (m+n+q≦1, 0<m<1, 0<n<1, and 0<q<1), and Li(₂₋ⱼ)FeᵣNiₛCoₜMnᵤSiO₄ (r+s+t+u≦1, 0<r<1, 0<s<1, 0<t<1, and 0<u<1).

Still alternatively, a nasicon compound expressed by AₓM₂(XO₄)₃ (general formula) (A=Li, Na, or Mg, M=Fe, Mn, Ti, V, Nb, or Al, X=S, P, Mo, W, As, or Si) can be used as the positive electrode active material. Examples of the nasicon compound are Fe₂(MnO₄)₃, Fe₂(SO₄)₃, and Li₃Fe₂(PO₄)₃. Further alternatively, a compound expressed by Li₂MPO₄F, Li₂MP₂O₇, or Li₅MO₄ (general formula) (M=Fe or Mn), a perovskite fluoride such as NaF₃ and FeF₃, a metal chalcogenide (a sulfide, a selenide, or a telluride) such as TiS₂ and MoS₂, an oxide with an inverse spinel structure such as LiMVO₄, a vanadium oxide (V₂O₅, V₆O₁₃, LiV₃O₈, or the like), a manganese oxide, an organic sulfur, or the like can be used as the positive electrode active material.

In the case where carrier ions are alkali metal ions other than lithium ions or alkaline-earth metal ions, the following may be used as the positive electrode active material: an alkali metal (e.g., sodium or potassium) or an alkaline-earth metal (e.g., calcium, strontium, barium, beryllium, or magnesium).

As the separator 13, an insulator such as cellulose (paper), polypropylene with pores, and polyethylene with pores can be used.

As an electrolyte of an electrolyte solution, a material which contains carrier ions is used. Typical examples of the electrolyte are lithium salts such as LiPF₆, LiClO₄, LiAsF₆, LiBF₄, LiCF₃SO₃, Li(CF₃SO₂)₂N, and Li(C₂F₅SO₂)₂N. One of these electrolytes may be used alone or two or more of them may be used in an appropriate combination and in an appropriate ratio.

Note that when carrier ions are alkali metal ions other than lithium ions, or alkaline-earth metal ions; instead of lithium in the above lithium salts, an alkali metal (e.g., sodium or potassium), an alkaline-earth metal (e.g., calcium, strontium, barium, beryllium, or magnesium) may be used for the electrolyte.

As a solvent of the electrolytic solution, a material with the carrier ion mobility is used. As the solvent of the electrolytic solution, an aprotic organic solvent is preferably used. Typical examples of aprotic organic solvents include ethylene carbonate (EC), propylene carbonate, dimethyl carbonate, diethyl carbonate (DEC), γ-butyrolactone, acetonitrile, dimethoxyethane, tetrahydrofuran, and the like, and one or more of these materials can be used. When a gelled high-molecular material is used as the solvent for the electrolyte solution, safety against liquid leakage and the like is improved. Further, the storage battery can be thinner and more lightweight. Typical examples of the gelled high-molecular material include a silicone gel, an acrylic gel, an acrylonitrile gel, polyethylene oxide, polypropylene oxide, a fluorine-based polymer, and the like. Alternatively, the use of one or more of ionic liquids (room temperature molten salts) which have features of non-flammability and non-volatility as a solvent of the electrolytic solution can prevent the storage battery from exploding or catching fire even when the storage battery internally shorts out or the internal temperature increases owing to overcharging or the like. An ionic liquid is a salt in the liquid state and has high ion mobility (conductivity). Further, the ionic liquid includes a cation and an anion. Examples of such an ionic liquid are an ionic liquid containing an ethylmethylimidazolium (EMI) cation and an ionic liquid containing an N-methyl-N-propylpiperidinium (PP₁₃) cation.

Instead of the electrolytic solution, a solid electrolyte including an inorganic material such as a sulfide-based inorganic material or an oxide-based inorganic material, or a solid electrolyte including a macromolecular material such as a polyethylene oxide (PEO)-based macromolecular material may alternatively be used. In the case where the solid electrolyte is used, the provision of a separator or a spacer can be omitted. Further, the battery can be entirely solidified; therefore, possibility of liquid leakage decreases and thus the safety of the battery dramatically improves.

A material with which lithium can be dissolved and precipitated or a material into and from which lithium ions can be inserted and extracted can be used for a negative electrode active material of the negative electrode active material layer 19; for example, a lithium metal, a carbon-based material, an alloy-based material, or the like can be used.

The lithium metal is preferable because of its low redox potential (3.045 V lower than that of a standard hydrogen electrode) and high specific capacity per unit weight and per unit volume (3860 mAh/g and 2062 mAh/cm³, respectively).

Examples of the carbon-based material include graphite, graphitizing carbon (soft carbon), non-graphitizing carbon (hard carbon), a carbon nanotube, graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) when lithium ions are intercalated into the graphite (while a lithium-graphite intercalation compound is formed). For this reason, a lithium-ion secondary battery can have a high operating voltage. In addition, graphite is preferable because of its advantages such as relatively high capacity per unit volume, small volume expansion, low cost, and safety greater than that of a lithium metal.

For the negative electrode active material, an alloy-based material or oxide which enables charge-discharge reactions by an alloying reaction and a dealloying reaction with lithium can be used. In the case where carrier ions are lithium ions, a material containing at least one of Al, Si, Ge, Sn, Pb, Sb, Bi, Ag, Au, Zn, Cd, In, Ga, and the like can be used as an alloy-based material, for example. Such elements have higher capacity than carbon. In particular, silicon has a significantly high theoretical capacity of 4200 mAh/g. For this reason, silicon is preferably used as the negative electrode active material. Examples of the alloy-based material using such elements include Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, as the negative electrode active material, an oxide such as SiO, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active materials, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case the negative electrode active material includes lithium ions and thus can be used in combination with a positive electrode active material that does not contain lithium ions, such as V₂O₅ or Cr₃O₈. In the where a material containing lithium ions is used as a positive electrode active material, the nitride containing lithium and a transition metal can be used for the negative electrode active material by extracting the lithium ions contained in the positive electrode active material in advance.

Alternatively, a material which causes a conversion reaction can be used as the negative electrode active material. For example, a transition metal oxide with which an alloying reaction with lithium is not caused, such as cobalt oxide (CoO), nickel oxide (NiO), or iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, or CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as a positive electrode active material because of its high potential.

The negative electrode active material layer 19 may further include a binder for increasing adhesion of active materials, a conductive additive for increasing the conductivity of the negative electrode active material layer 19, and the like in addition to the above negative electrode active materials.

In the secondary battery, for example, the separator 13 has a thickness of approximately 25 μm, the positive electrode current collector 12 has a thickness of approximately 20 μm to 40 μm, the positive electrode active material layer 18 has a thickness of approximately 100 μm, the negative electrode active material layer 19 has a thickness of approximately 100 μm, and the negative electrode current collector 14 has a thickness of approximately 20 μm to 40 μm. The film 10 has a thickness of 0.6 mm. Although the adhesive layer 30 is only partly shown in FIG. 7E, only a themocompression-bonded portion of a layer made of polypropylene which is provided on the surface of the film 10 is the adhesive layer 30.

FIG. 7E shows an example in which the bottom side of the film 10 is fixed and pressure-bonded. In this case, the top side is greatly bent and a step is formed. Thus, when a plurality of combinations of the above stacked layers (e.g., eight or more combinations) is provided inside the folded film 10, the step is large and the top side of the film 10 might be too stressed. Furthermore, an end face of the top side of the film might be misaligned with an end face of the bottom side of the film. To prevent misalignment of the end faces, a step may also be provided for the bottom side of the film and pressure bonding may be performed at a center portion so that stress is uniformly applied.

Here, a current flow in charging a secondary battery will be described with reference to FIG. 7F. When a secondary battery using lithium is regarded as a closed circuit, lithium ions transfer and a current flows in the same direction. Note that in the secondary battery using lithium, an anode and a cathode change places in charge and discharge, and an oxidation reaction and a reduction reaction occur on the corresponding sides; hence, an electrode with a high redox potential is called a positive electrode and an electrode with a low redox potential is called a negative electrode. For this reason, in this specification, the positive electrode is referred to as a “positive electrode” and the negative electrode is referred to as a “negative electrode” in all the cases where charge is performed, discharge is performed, a reverse pulse current is supplied, and a charging current is supplied. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the term “anode” or “cathode” is used, whether it is at the time of charging or discharging is noted and whether it corresponds to a positive electrode or a negative electrode is also noted.

Two terminals in FIG. 7F are connected to a charger, and a secondary battery 40 is charged. As the charge of the secondary battery 40 proceeds, a potential difference between electrodes increases. The positive direction in FIG. 7F is the direction in which a current flows from one terminal outside the secondary battery 40 to the positive electrode current collector 12, flows from the positive electrode current collector 12 to the negative electrode current collector 14 in the secondary battery 40, and flows from the negative electrode to the other terminal outside the secondary battery 40. In other words, a current flows in the direction of a flow of a charging current.

Although an example of a small battery used in a portable information terminal or the like is described in this embodiment, one embodiment of the present invention is not particularly limited to this example. Application to a large battery provided in a vehicle or the like is also possible.

Although an example of application to a lithium-ion secondary battery is described in this embodiment, one embodiment of the present invention is not limited to this example. Application to a variety of secondary batteries such as a lead storage battery, a lithium-ion polymer secondary battery, a nickel-hydrogen storage battery, a nickel-cadmium storage battery, a nickel-iron storage battery, a nickel-zinc storage battery, a silver oxide-zinc storage battery, a solid-state battery, and an air battery is also possible. Application to a variety of power storage devices such as a primary battery, a capacitor, and a lithium-ion capacitor is also possible. Furthermore, application to a solar cell, an optical sensor, a touch sensor, a display device, a flexible printed circuit (FPC), an optical film (e.g., a polarizing plate, a retardation plate, a prism sheet, a light reflective sheet, and a light diffusion sheet), and the like is also possible.

### Embodiment 2

In this embodiment, an example in which a plurality of combinations of stacked layers that are partly different from those in Embodiment 1 is provided inside the folded film 10 will be described.

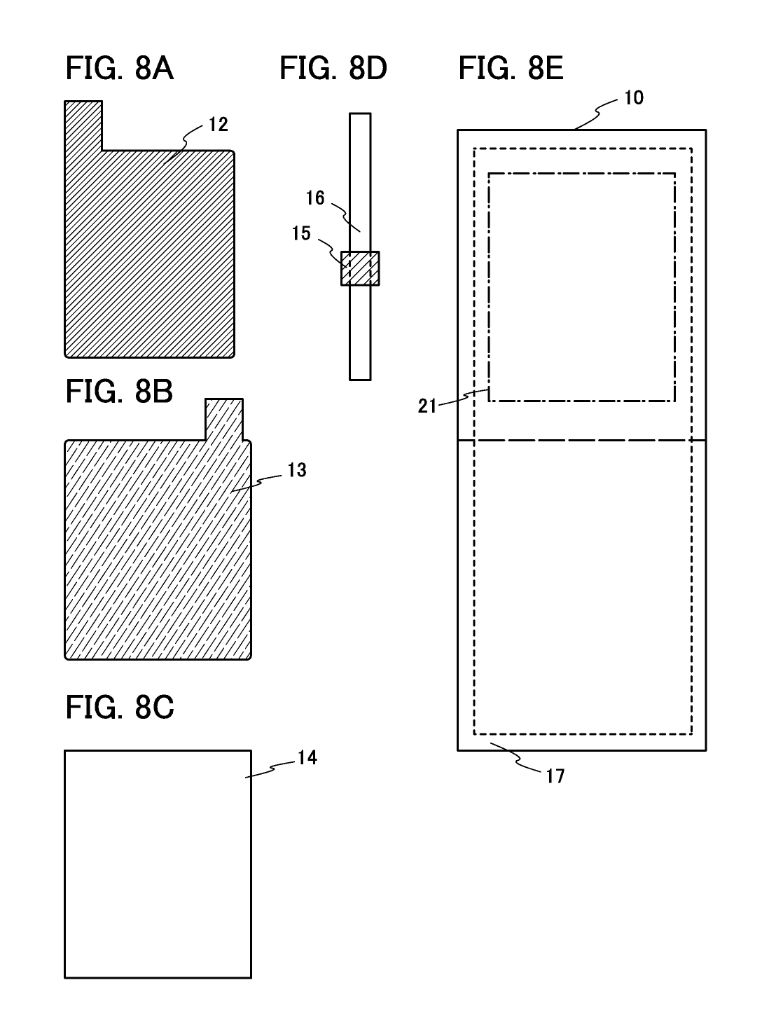

FIG. 8A is a top view of the positive electrode current collector 12. FIG. 8B is a top view of the negative electrode current collector 14. FIG. 8C is a top view of the separator 13. FIG. 8D is a top view of the lead electrode 16. FIG. 8E is a top view of the film 10.

The dimensions of the positive electrode current collector, the negative electrode current collector, and the separator are substantially the same in FIGS. 8A to 8E. A region 21 surrounded by a chain line in FIG. 8E has substantially the same dimensions as the separator in FIG. 8C. A region between a dotted line and an end face in FIG. 8E is a thermocompression-bonded region 17.

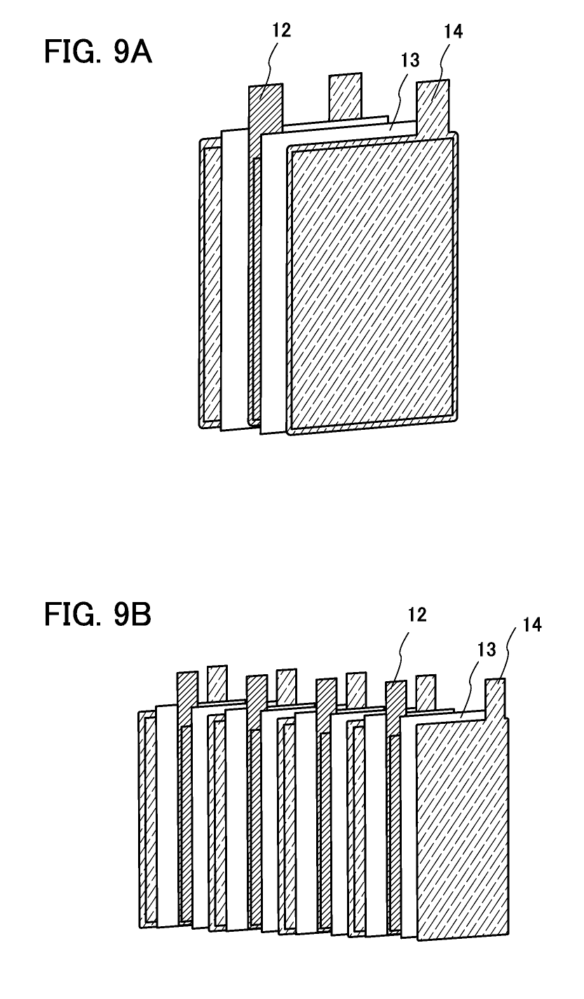

FIG. 9A is a perspective view of two combinations. An example in which the positive electrode current collector 12 is sandwiched between positive electrode active material layers is illustrated. Specifically, the negative electrode current collector 14, a negative electrode active material layer, the separator 13, a positive electrode active material layer, the positive electrode current collector 12, a positive electrode active material layer, a separator, a negative electrode active material layer, a negative electrode current collector are stacked in this order. Although two separators are illustrated in FIG. 9A, one separator may be folded and the positive electrode current collector 12 may be placed inside the folded separator.

The negative electrode current collector may be sandwiched between negative electrode active material layers. FIG. 9B illustrates an example in which three negative electrode current collectors each sandwiched between negative electrode active material layers, four positive electrode current collectors each sandwiched between positive electrode active material layers, and eight separators are sandwiched between two negative electrode current collectors each having one surface that is provided with a negative electrode active material layer.

In the above case, four positive electrode current collectors are all fixed and electrically connected at a time by ultrasonic welding. Furthermore, when ultrasonic welding is performed with the four positive electrode current collectors overlapping with lead electrodes, they can be electrically connected efficiently.

A protruding portion of a positive electrode current collector is also called a tab portion. Ultrasonic welding can be performed in such a manner that vibration is applied by ultrasonic wave to the tab portion of the positive electrode current collector placed so as to overlap with a tab portion of another positive electrode current collector, while pressure is applied thereto.

The tab portion is likely to be cracked or cut by stress due to external force applied after fabrication of a secondary battery.

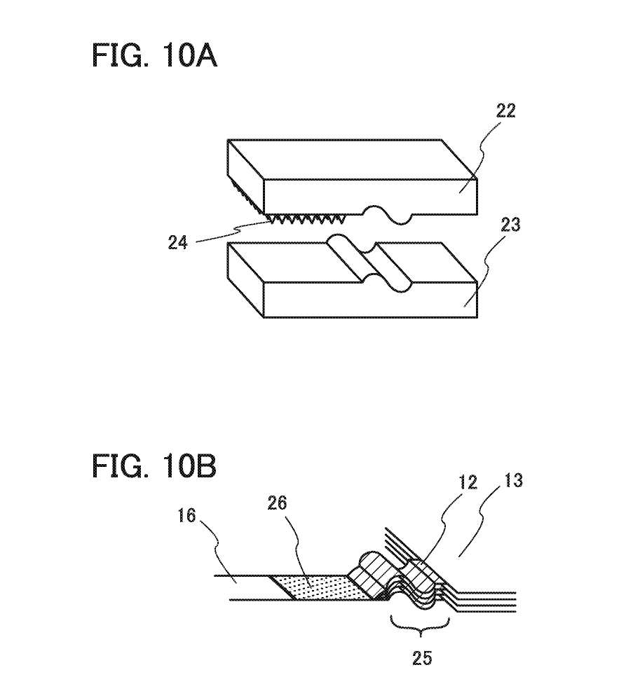

Thus, an ultrasonic welding apparatus including bonding dies illustrated in FIG. 10A is used in this embodiment. Note that only top and bottom bonding dies of the ultrasonic welding apparatus are illustrated in FIG. 10A for simplicity.

Tab portions of four positive electrode current collectors and lead electrodes are positioned between a first bonding die 22 provided with projections 24 and a second bonding die 23. When ultrasonic welding is performed with a region that needs to be welded overlapping with the projections 24 and pressure is applied, a bent portion 25 is formed in the tab portion between a welded region 26 and a region of the tab portion protruding from an end portion of the separator 13, as illustrated in FIG. 10B.

This bent portion 25 can relieve stress due to external force applied after fabrication of a secondary battery.

Furthermore, the ultrasonic welding apparatus including the bonding dies illustrated in FIG. 10A can perform ultrasonic welding and form the bent portion 25 at a time; thus, a secondary battery can be fabricated without increasing the number of fabricating steps. Note that ultrasonic bonding and formation of the bent portion 25 may be separately performed.

In addition, tab portions of five negative electrode current collectors are also all welded to be electrically connected by ultrasonic welding described above.

The bent portion 25 is not necessarily formed in the tab portion. To relieve stress, the shape of the tab portion of the positive electrode current collector may be modified.

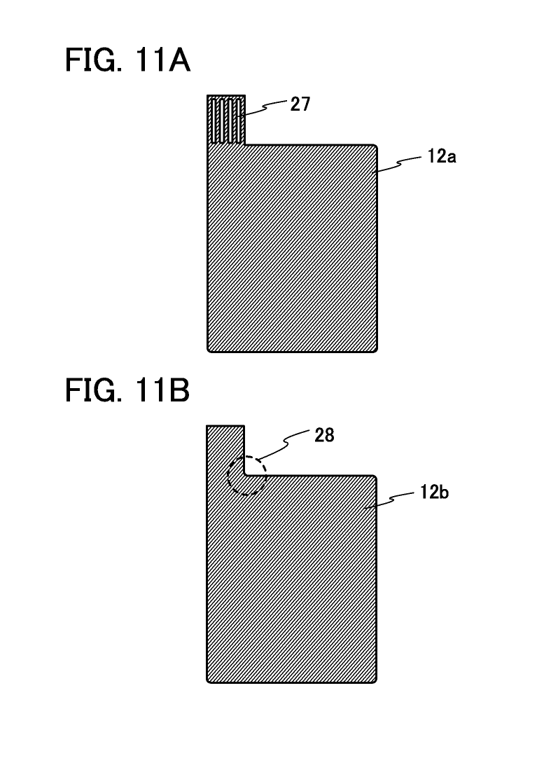

FIG. 11A illustrates an example of a top view of a positive electrode current collector 12a as a modification example. A tab portion of the positive electrode current collector 12a may be provided with slits 27 so that stress due to external force applied after fabrication of a secondary battery can be relieved.

FIG. 11B illustrates an example of a top view of a positive electrode current collector 12b as another modification example. A corner of a region 28, which is surrounded by a dotted line, of a tab portion of the positive electrode current collector 12b is rounded off to relieve concentration of stress. Furthermore, the corner of the region 28 is preferably more rounded off than the other corners to have a large radius of curvature.

Alternatively, a high-strength material may be used for a positive electrode current collector and the positive electrode current collector may be formed to have a thickness of 10 μm or less, in order to relieve stress due to external force applied after fabrication of a secondary battery.

It is needless to say that two or more of the above examples may be combined to relieve concentration of stress in the tab portion.

Note that this embodiment can be combined with Embodiment 1.

### Embodiment 3

In this embodiment, examples of electronic devices incorporating any of the lithium-ion secondary batteries described in Embodiments 1 and 2 will be described.

The secondary battery fabricated according to Embodiment 1 or 2 includes, as an exterior body, a thin film having flexibility and thus can be bonded to a support structure body with a curved surface and can change its form along the curved surface of a region of the support structure body that has a large radius of curvature.

In the above structure, the exterior body of the secondary battery can be deformed repeatedly from a flat state, within a range of a curvature radius of 10 mm or more, preferably a curvature radius of 30 mm or more. One or two sheets of the above multilayer film are used as the exterior body of the secondary battery. When the secondary battery with a laminated structure is bent to have an arc-shaped cross section, the battery is sandwiched by the two curved surfaces of the film. Approximating the curve in a cross section of the curved surface of the film by a circle, the radius is called curvature radius and the reciprocal is called curvature. Note that the cross-sectional shape of the secondary battery is not limited to a simple arc shape and the cross section can be partially arc-shaped. For example, the cross-sectional shape can be a wavy shape or an S shape.

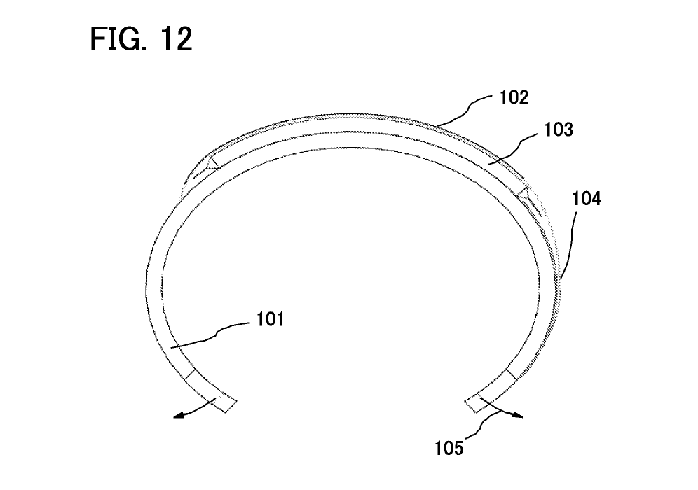

Next, a display module to be attached to the secondary battery is prepared. The display module refers to a display panel provided with at least an FPC. FIG. 12 is a cross-sectional schematic view of an electronic device. The electronic device in FIG. 12 includes a display portion 102, an FPC, and a driver circuit and preferably further includes a converter for power feeding from a secondary battery 103. The support structure body 101 is in the form of a bracelet obtained by curving a band-like structure body. At least part of the support structure body 101 has flexibility and can be moved in the direction of arrows 105; thus, the electronic device can be put around a wrist.

In the display module, the display portion 102 is flexible and a display element is provided over a flexible film. The secondary battery 103 and the display portion 102 are preferably disposed so as to partly overlap with each other. When the secondary battery 103 and the display portion 102 are disposed so as to partly or entirely overlap with each other, the electrical path, i.e., the length of a wiring, from the secondary battery 103 to the display portion can be shortened, whereby power consumption can be reduced.

The electronic device illustrated in FIG. 12 includes the support structure body 101, the secondary battery 103, a control board (not shown), the display portion 102, and a cover 104. Specifically, the secondary battery 103 is provided over the support structure body 101, the control board is provided over the secondary battery 103, and the display portion 102 and the cover 104 are provided over the control board. In addition, the electronic device is provided with an antenna (not shown) for wireless charging, and the wireless charging can be performed.

The support structure body 101 is flexible and thus can be easily bent. Note that a material other than plastic can be used for the support structure body 101.

The control board has slits to bend it, and is provided with a communication device, a microcomputer, a storage device, an FPGA, a DA converter, a charge control IC, a level shifter, and the like. The control board is connected to a display module including the display portion 102 through an input/output connector.

In addition, the display portion 102 may be provided with a touch panel so that input of data to the electronic device and operation of the electronic device can be performed with the touch panel.

Examples of methods for manufacturing the display element over the flexible film include a method in which the display element is directly formed over the flexible film; a method in which a layer including the display element is formed over a rigid substrate such as a glass substrate, the substrate is removed by etching, polishing, or the like, and then the layer including the display element and the flexible film are attached to each other; a method in which a separation layer is provided over a rigid substrate such as a glass substrate, a layer including the display element is formed thereover, the rigid substrate and the layer including the display element are separated from each other using the separation layer, and then the layer including the display element and the flexible film are attached to each other; and the like.

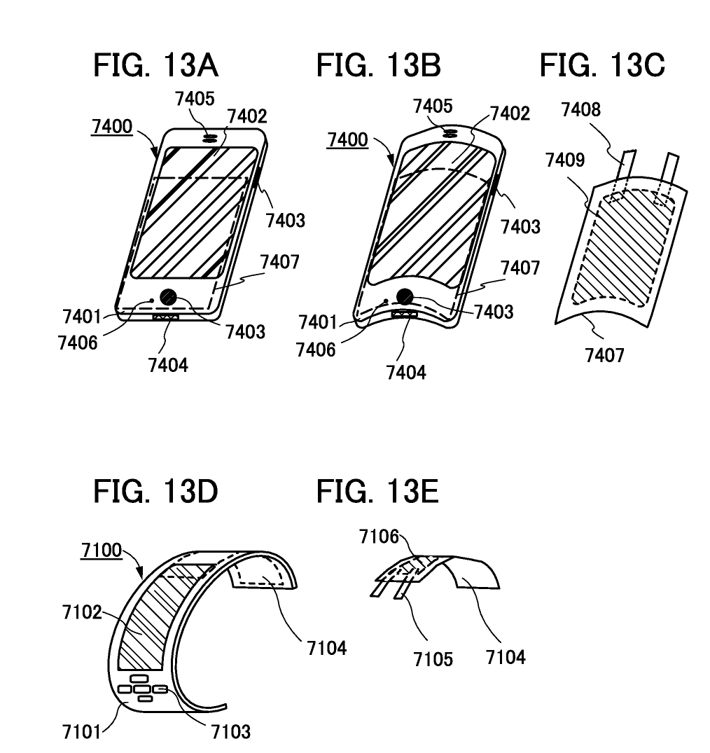

FIGS. 13A to 13E illustrate examples of other electronic devices.

Examples of an electronic device using a flexible power storage device include display devices (also referred to as televisions or television receivers) such as head mounted displays and goggle type displays, monitors of computers or the like, digital cameras, digital video cameras, digital photo frames, mobile phones (also referred to as cellular phones or mobile phone devices), portable game machines, portable information terminals, audio reproducing devices, and large game machines such as pachinko machines.

In addition, a flexible power storage device can be incorporated along a curved inside/outside wall surface of a house or a building or a curved interior/exterior surface of a car.

FIG. 13A illustrates an example of a mobile phone handset. A cellular phone 7400 is provided with a display portion 7402 incorporated in a housing 7401, an operation button 7403, an external connection port 7404, a speaker 7405, a microphone 7406, and the like. Note that the mobile phone 7400 includes a power storage device 7407.

FIG. 13B illustrates the mobile phone 7400 that is bent. When the whole mobile phone 7400 is bent by the external force, the power storage device 7407 included in the mobile phone 7400 is also bent. FIG. 13C illustrates the bent power storage device 7407. The power storage device 7407 is a laminated storage battery (also referred to as a film-covered battery). The power storage device 7407 is fixed in a state of being bent. Note that the power storage device 7407 includes a lead electrode 7408 electrically connected to a current collector 7409. For example, a film serving as an exterior body of the power storage device 7407 is embossed, so that the power storage device 7407 has high reliability even when bent.

FIG. 13D illustrates an example of a bangle-type mobile phone. A mobile phone 7100 includes a housing 7101, a display portion 7102, an operation button 7103, and a power storage device 7104. FIG. 13E illustrates the power storage device 7104 which can be bent. When the mobile phone is worn on a user's arm, the housing changes its form and the curvature of a part or the whole of the power storage device 7104 is changed. Specifically, the curvature of a part or the whole of the housing or the main surface of the power storage device 7104 is changed within a range of a curvature radius of 10 mm or more and 150 mm or less. Since the exterior body of the power storage device 7104 is formed of the multilayer film of one embodiment of the present invention, the power storage device 7104 can maintain high reliability even after being bent many times. Note that the power storage device 7104 includes a lead electrode 7105 electrically connected to a current collector 7106.

The use of power storage devices that can be bent in vehicles enables production of next-generation clean energy vehicles such as hybrid electric vehicles (HEVs), electric vehicles (EVs), and plug-in hybrid electric vehicles (PHEVs).

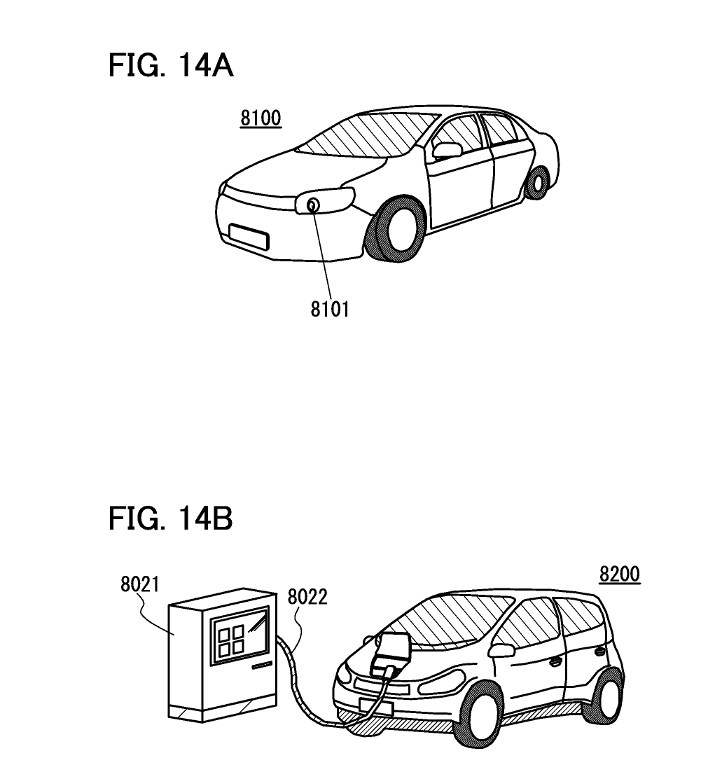

FIGS. 14A and 14B each illustrate an example of a vehicle using one embodiment of the present invention. An automobile 8100 illustrated in FIG. 14A is an electric vehicle that runs on the power of an electric motor. Alternatively, the automobile 8100 is a hybrid electric vehicle capable of driving using either the electric motor or the engine as appropriate. In the case where a laminated secondary battery is provided in the vehicle, a battery module including a plurality of laminated secondary batteries is placed in one place or more than one places. According to one embodiment of the present invention, a power storage device itself can be made more compact and lightweight, and for example, when the power storage device having a curved surface is provided on the inside of a tire of a vehicle, the vehicle can be a high-mileage vehicle. Furthermore, a power storage device that can have various shapes can be provided in a small space in a vehicle, which allows a space in a trunk and a space for riders to be secured. The automobile 8100 includes the power storage device. The power storage device is used not only for driving an electric motor, but also for supplying electric power to a light-emitting device such as a headlight 8101 or a room light (not illustrated).

The power storage device can also supply electric power to a display device included in the automobile 8100, such as a speedometer or a tachometer. Furthermore, the power storage device can supply electric power to a semiconductor device included in the automobile 8100, such as a navigation system.

FIG. 14B illustrates an automobile 8200 including the power storage device. The automobile 8200 can be charged when the power storage device is supplied with electric power through external charging equipment by a plug-in system, a contactless power feeding system, or the like. In FIG. 14B, the power storage device included in the automobile 8200 is charged with the use of a ground-based charging apparatus 8021 through a cable 8022. In charging, a given method such as CHAdeMO or Combined Charging System may be employed as a charging method, the standard of a connector, or the like as appropriate. The charging apparatus 8021 may be a charging station provided in a commerce facility or a power source in a house. For example, with the use of a plug-in technique, a power storage device 8024 included in the automobile 8200 can be charged by being supplied with electric power from outside. The charging can be performed by converting AC electric power into DC electric power through a converter such as an AC-DC converter.

Further, although not illustrated, the vehicle may include a power receiving device so as to be charged by being supplied with electric power from an above-ground power transmitting device in a contactless manner. In the case where the contactless power supply system is employed, by fitting the power transmitting device in a road or an exterior wall, charging can be performed not only when the electric vehicle is stopped but also when driven. In addition, the contactless power supply system may be utilized to perform transmission/reception of electric power between two vehicles. Furthermore, a solar cell may be provided in the exterior of the automobile to charge the power storage device when the automobile stops or moves. To supply electric power in such a contactless manner, an electromagnetic induction method or a magnetic resonance method can be used.

According to one embodiment of the present invention, the degree of flexibility in place where the power storage device can be provided is increased and thus a vehicle can be designed efficiently. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the driving distance. Further, the power storage device included in the vehicle can be used as a power source for supplying electric power to products other than the vehicle. In such a case, the use of a commercial power source can be avoided at peak time of electric power demand.

This embodiment can be combined with Embodiment 1 or 2.

### Embodiment 4

As other examples of electronic devices using power storage devices, medical electronic devices that can acquire biological data will be described.

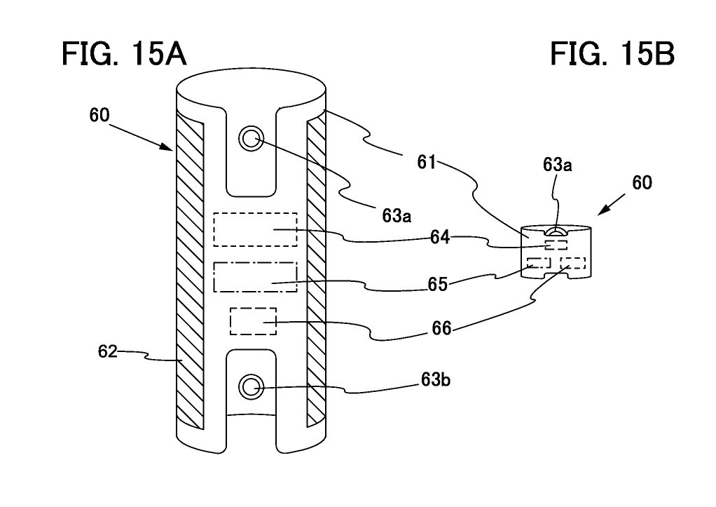

An electronic device 60 in FIGS. 15A and 15B includes a housing 61 that is provided with one or more sensors having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays. With sensors 63a and 63b, for example, data on an environment (e.g., temperature) where the power storage device is placed can be determined and stored in a memory circuit 64. FIG. 15A shows an example of a bracelet-type electronic device with a display portion 62 on the housing 61, the display portion 62 having a touch input sensor; and FIG. 15B shows an example of a ring-type electronic device without a display portion.

For example, the electronic device 60 is provided with a light source such as an LED so that light from the light source can be emitted to a skin overlapping with the electronic device 60 to measure a change in bloodstream from reflected light from the inside of the skin and acquire pulse data by arithmetic processing. Measurement is performed at more than one portions and the average of the measurement results is used to acquire accurate biological data. The electronic device 60 is further provided with a circuit 65 that can perform signal processing operation, such as a CPU.

The electronic device 60 may be provided with a sensor that can acquire biological data other than pulse data. Examples of other biological data include body temperature, blood pressure, the amount of activity, the number of steps taken, blood oxygen level, and the proportion of subcutaneous fat.

Although FIG. 15A illustrates the electronic device including the display portion 62, one embodiment of the present invention is not particularly limited thereto. Even without the display portion 62, acquired biological data can be checked by being displayed on another electronic device such as a mobile phone or a smartphone when at least a circuit 66 (including an antenna, for example) that can send and receive biological data is provided. In the case where a user who wears the electronic device 60 on his or her arm is a person with chronic disease or a person who requires nursing care, it is preferable that data be sent also to medical facilities such as a hospital in a remote location. In that case, data can be provided to the hospital in real time and the user can obtain directions regarding a proper treatment from a doctor in the hospital, for example, with a mobile phone or a smartphone.

The electronic device 60 may have a function of acquiring current biological data of a user as well as positional data received by GPS of the electronic device 60 and automatically informing a medical facility of the data urgently when he or she who wears the electronic device 60 on his or her arm collapses on a road because of physical abnormality. When data of a donor card or data on a user's name, age, blood type, and the like are stored in the circuit 64, a saver can obtain necessary information on the user by using the electronic device 60 even if he or she is unconscious.

This embodiment can be combined with any one of Embodiments 1 to 3.

This application is based on Japanese Patent Application serial no. 2013-236672 filed with Japan Patent Office on Nov. 15, 2013, the entire contents of which are hereby incorporated by reference.

What is claimed is:

1. A multilayer film comprising:
a metal layer; and
a first resin layer comprising a first resin,
wherein the first resin has a durometer hardness of A90 or less, and
wherein the first resin does not break when it is stretched to 150% of its original length in one direction.

2. The multilayer film according to claim 1, wherein the metal layer comprises aluminum.

3. The multilayer film according to claim 1, wherein the metal layer and the first resin layer are stacked and in contact with each other.

4. The multilayer film according to claim 1, wherein the first resin layer has a thickness of greater than or equal to 100 μm and less than or equal to 5 mm.

5. The multilayer film according to claim 1, further comprising:
a second resin layer comprising a second resin.

6. The multilayer film according to claim 1, wherein the first resin is a silicone resin.

7. A secondary battery comprising:
a positive electrode;
a negative electrode;
a separator; and
a multilayer film surrounding the positive electrode, the negative electrode, and the separator,
wherein the multilayer film comprises:
a metal layer; and
a first resin layer comprising a first resin,
wherein the first resin has a durometer hardness of A90 or less, and
wherein the first resin does not break when it is stretched to 150% of its original length in one direction.

8. The secondary battery according to claim 7, wherein the metal layer comprises aluminum.

9. The secondary battery according to claim 7, wherein the metal layer and the first resin layer are stacked and in contact with each other.

10. The secondary battery according to claim 7, wherein the first resin layer has a thickness of greater than or equal to 100 μm and less than or equal to 5 mm.

11. The secondary battery according to claim 7, further comprising:
a second resin layer comprising a second resin.

12. The secondary battery according to claim 7, further comprising:
a lead electrode electrically connected to one of the positive electrode and the negative electrode through a tab portion,
wherein the tab portion is bent.

13. The secondary battery according to claim 7, wherein the secondary battery has a function of changing a shape of the secondary battery.

14. An electronic device comprising the secondary battery according to claim 7.

15. A secondary battery comprising:
a positive electrode;
a negative electrode;
a separator; and
a multilayer film surrounding the positive electrode, the negative electrode, and the separator,
wherein the multilayer film comprises:
a metal layer; and
a first resin layer comprising a first resin,
wherein the first resin is a silicone resin.

16. The secondary battery according to claim 15, wherein the metal layer comprises aluminum.

17. The secondary battery according to claim 15, wherein the metal layer and the first resin layer are stacked and in contact with each other.

18. The secondary battery according to claim 15, wherein the first resin layer has a thickness of greater than or equal to 100 μm and less than or equal to 5 mm.

19. The secondary battery according to claim 15, further comprising:
a second resin layer comprising a second resin.

20. An electronic device comprising the secondary battery according to claim 15.
